(19) United States
(12) Patent Application Publication
(10) Pub. No.: US 2026/0122079 A1
(43) Pub. Date: Apr. 30, 2026

(54) METHOD AND SYSTEM FOR DETECTING, TRACKING AND TRACING POTENTIAL FRAUD IN A COMPUTER NETWORK

(71) Applicant: FINANCIAL NETWORK ANALYTICS LTD, London (GB)

(72) Inventors: Florian Loecker, London (GB); Kimmo Soramäki, London (GB)

(21) Appl. No.: 18/928,817

(22) Filed: Oct. 28, 2024

(51) Int. Cl. H04L 9/40

(52) U.S. Cl. CPC H04L 63/1416

(57) ABSTRACT

Disclosed is method for detecting, tracking and tracing a potential fraud in a computer network (DN) comprising plurality of nodes (PoN) at least includes first node (FN), second node (SN) and third node (TN), FN is associated with user having sensitive data (SD), method comprising enabling FN for: generating first case (FC) corresponding to first transaction (FT); subscribing to FC; generating first cryptographic key (CK); tokenizing SD based on first CK; and sharing first case data (FCD) with PoN, method comprises enabling SN for: receiving FCD; subscribing to FC; deciphering received FCD; comparing deciphered FCD with second case data (SCD); and notifying TN of FT, when the compared FCD and SCD are different; method comprises enabling TN for: receiving FCD; subscribing to FC; deciphering received FCD; comparing deciphered FCD with third case data (TCD); and notifying subsequent nodes of FT, when compared FCD and TCD are different.

### TECHNICAL FIELD

The present disclosure relates to methods for detecting, tracking and tracing potential frauds in computer networks. Moreover, the present disclosure also relates to systems for detecting, tracking and tracing potential frauds in computer networks.

### BACKGROUND

In the field of financial transactions, fraud (or fraudulent or suspicious activity(s) or transactions) detection and prevention are critical concerns for banks, payment service providers, and other financial institutions. With the increasing sophistication of fraudulent activities, the need to track and trace suspicious funds across multiple entities has become paramount. However, sharing sensitive data, such as personally identifiable information, across different entities poses significant challenges, particularly in ensuring privacy and data security.

Existing solutions for detecting, tracking and tracing fraudulent funds often rely on direct data sharing between the multiple entities. The existing solutions are typically supported by local legal frameworks that permit a higher degree of data sharing. For instance, some jurisdictions allow financial institutions to exchange customer data freely, which can facilitate fraud detection, tracking and tracing, but at the expense of privacy. Additionally, existing solutions utilize federated learning techniques, where models are trained across decentralized data sources without sharing raw data. However, these existing solutions have limitations, particularly in constructing graph features, which are essential for detecting, tracking and tracing complex fraud patterns across the multiple entities.

Despite the advancements in data-sharing technologies and federated learning, the aforementioned existing solutions are inadequate in addressing the need for privacy-preserving fraud detection, tracking and tracing across borders and Financial Institutions. Moreover, the reliance on local legal frameworks limits the applicability of these solutions in regions with stricter data privacy laws. Furthermore, the inability to effectively construct graph features in a distributed computer setting, hampers the detection, tracking and tracing of sophisticated fraud schemes, such as money laundering through multiple banks.

### SUMMARY

The aim of the present disclosure is to provide a method and a system to detect, track and trace a potentially fraudulent activities across multiple financial institutions without disclosing personal identifiable information of the user. The aim of the present disclosure is achieved by a method and a system for detecting, tracking and tracing a potential fraud in a computer network as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 is an illustration of a flowchart depicting steps of a method for detecting, tracking and tracing a potential fraud in a computer network, in accordance with an embodiment of the present disclosure;

FIG. 2 is an illustration of a block diagram of a system for detecting, tracking and tracing a potential fraud in a computer network, in accordance with an embodiment of the present disclosure; and

FIG. 3 is a schematic illustration of a computer network, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In a first aspect, the present disclosure provides a method for detecting, tracking and tracing a potential fraud in a computer network, which may be a computer network, comprising a plurality of nodes representing a plurality of participants, wherein the plurality of nodes at least includes a first node, a second node and a third node, wherein the first node is associated with a user having sensitive data,
the method comprising enabling the first node for:
   generating a first case corresponding to a first transaction;
   subscribing to the first case;
   generating a first cryptographic key associated with the first node;
   tokenizing the sensitive data based on the first cryptographic key; and
   sharing the first case data with the plurality of nodes in the network associated with the first case, wherein the first case data comprises:
      a case identifier,
      the first cryptographic key, and
      the tokenized data corresponding to the first transaction;
wherein the method comprises enabling the second node for:
   receiving the first case data;
   subscribing to the first case;
   deciphering the received first case data using the first cryptographic key;
   comparing the deciphered first case data with second case data corresponding to a second transaction; and
   notifying the third node of the first transaction, when the compared first case and second case data are different, for detecting, tracking and tracing the potential fraud in the network;
wherein the method comprises enabling the third node for:
   receiving the first case data;
   subscribing to the first case;
   deciphering the received first case data using the first cryptographic key;
   comparing the deciphered first case data with third case data corresponding to a third transaction; and
   notifying one or more subsequent nodes of the first transaction, when the compared first case and third case data are different, for detecting, tracking and tracing the potential fraud in the network; and
wherein the method comprises notifying at least one of the subscribed first node, second node, third node, one or more subsequent nodes of the at least one of the second transaction, the third transaction, one or more subsequent transaction, for detecting, tracking and tracing the potential fraud in the computer network which may be a computer network.

The present disclosure provides an aforementioned method that efficiently obfuscates sensitive data of a user for effective fraud detection, tracking and tracing across multiple participants, such as banks and payment service providers, in a network. Moreover, the method provides a collaborative and secure framework for detecting, tracking and tracing potential fraud or suspicious financial activities while maintaining the privacy of the sensitive user data. Furthermore, generating the cryptographic key to tokenize/obfuscate the sensitive data ensures that sensitive information, such as personally identifiable information (PII), is protected during transmission and storage within the network. The cryptographic key adds a layer of security, addressing privacy concerns while allowing for data sharing in a secure manner. Furthermore, deciphering the case data and comparing it with its own transactions is critical in detecting, tracking and tracing patterns of fraudulent activities. Furthermore, notifying the third node of the first transaction ensures that all relevant nodes are involved in tracking and tracing the potential fraud or suspicious transaction, increasing the likelihood of identifying and intercepting fraudulent behavior at an early stage.

In a second aspect, the present disclosure provides a non-transitory computer-readable medium carrying instructions that when loaded into and executed by a data processing arrangement causes the data processing arrangement to execute operations, the operations comprising steps of the method according to the aforementioned first aspect.

The present disclosure provides an aforementioned non-transitory computer-readable medium that efficiently obfuscates sensitive data of a user for effective fraud detection, tracking and tracing across multiple participants, such as banks and payment service providers, potentially across national borders. Moreover, the data processing arrangement provides a collaborative and secure framework for detecting, tracking and tracing potential fraud or suspicious financial activities while maintaining the privacy of the sensitive user data. Furthermore, encoding the method as a set of instructions on the non-transitory computer-readable medium ensures that the method can be easily integrated into different environments, whether on-premises or in the cloud and can be adopted by different nodes without requiring significant changes to the existing infrastructure. In a distributed computer network, the distributed nature of the network ensures that no single node has undue control or access over the entire network, promoting trust among nodes.

In a third aspect, the present disclosure provides a system for detecting, tracking and tracing a potential fraud in a computer network, which may be a computer network, comprising a plurality of nodes representing a plurality of participants, wherein the plurality of nodes at least includes a first node, a second node and a third node, wherein the first node is associated with a user having sensitive data, the system comprising a data processing arrangement,
wherein the data processing arrangement is configured to enable the first node to:
   generate a first case corresponding to a first transaction;
   subscribe to the first case;
   generate a first cryptographic key associated with the first node;
   tokenize the sensitive data based on the first cryptographic key; and
   share the first case data with the plurality of nodes in the network associated with the first case, wherein the first case data comprises:
      a case identifier,
      the first cryptographic key, and
      the tokenized data corresponding to the first transaction;
wherein the data processing arrangement is configured to enable the second node to:
   receive the first case data:
   subscribe to the first case;
   decipher the received first case data using the first cryptographic key;
   compare the deciphered first case data with second case data corresponding to a second transaction; and
   notify the third node of the first transaction, when the compared first case and second case data are different, for detecting, tracking and tracing the potential fraud in the network;
wherein the data processing arrangement is configured to enable the third node to:
   Receive the First Case Data;
   subscribe to the first case;
   decipher the received first case data using the first cryptographic key;
   compare the deciphered first case data with third case data corresponding to a third transaction; and
   notify one or more subsequent nodes of the first transaction, when the compared first case and third case data are different, for detecting, tracking and tracing the potential fraud in the network; and
wherein the data processing arrangement is configured to notify at least one of the subscribed first node, second node, third node, one or more subsequent nodes of the at least one of the second transaction, the third transaction, one or more subsequent transaction, for detecting, tracking and tracing the potential fraud in the network.

The present disclosure provides an aforementioned system that efficiently obfuscates sensitive data of a user for effective fraud detection, tracking and tracing across multiple participants, such as banks and payment service providers, in a distributed computer network. Moreover, the data processing arrangement is configured to provide a collaborative and secure framework for detecting, tracking and tracing potential fraud or suspicious financial activities while maintaining the privacy of the user's sensitive data. Furthermore, the data processing arrangement is configured to generate the cryptographic key to tokenize/obfuscate the sensitive data ensures that sensitive information, such as personally identifiable information (PII), is protected during transmission and storage within the distributed network. The cryptographic key adds a layer of security, addressing privacy concerns while allowing for data sharing in a secure manner. Furthermore, the data processing arrangement configured to decipher the case data and compare it with its own transactions is critical in detecting, tracking and tracing patterns of fraudulent activities. Furthermore, the data processing arrangement is configured to notify the third node of the first transaction which ensures that all relevant nodes are involved in tracking and tracing the potential fraud or suspicious transaction, increasing the likelihood of identifying and intercepting fraudulent behavior at an early stage.

Throughout the present disclosure, the term “distributed network” refers to a network architecture in which the plurality of nodes work together in an interconnected manner to perform required tasks, such as, share data or provide financial services. Notably, the distributed network allows consumers, merchants, financial institutions and other third parties to interact with each other and strengthen their relationships by enabling efficient and secure transaction processing and reducing risks. Moreover, each node amongst the plurality of nodes operates independently but collaborates with other nodes amongst the plurality of nodes to maintain integrity of the distributed network. Furthermore, the purpose of creating the distributed network of the plurality of nodes representing the plurality of participants is to enable secure, efficient and decentralized interactions among the plurality of nodes. For example, in an environment like financial systems, it is essential to have a network where data and processing tasks are not centralized but distributed among various participants to enhance data security and provide redundancy. It will be appreciated that the distributed network allows the plurality of participants to share data and resources securely and enables collaborative tasks such as fraud detection, transaction processing, or distributed computing. Throughout the present disclosure, the term “detecting” refers to a process of identifying, observing or discovering indications of a potential fraud or suspicious activity or transaction, or anomalies within the distributed network that could signify fraud. Notably, detecting fraud is crucial to safeguarding the distributed network and the participants from malicious activities. It helps to prevent financial loss, protect the sensitive data and the like. Throughout the present disclosure, the term “tracking” refers to a process of continuously monitoring the position, status, and/or behavior of the data or assets between the nodes within the distributed network, thereby, providing real-time updates or history of its path or state. Throughout the present disclosure, the term “tracing” refers to a process of monitoring and documenting the flow of data or assets between the nodes within the distributed network. In other words, tracking and tracing enables to continuously follow the status of a transaction, identify potential issues, or ensure that communication between the nodes is secure and accurate. Notably, tracking and tracing fraud is crucial to safeguarding the distributed network and the participants from malicious activities cropping up at one or more nodes. Consequently, detecting, tracking and tracing a potential fraud in the distributed network helps to prevent financial loss, protect the sensitive data, and the like.

Moreover, the method is designed for detecting, tracking and tracing potentially fraudulent funds in the distributed network such that privacy is enhanced or preserved, but with a possibility to share data when needed. Throughout the present disclosure, the term “sensitive data” refers to a data related to the user that, if exposed, could compromise the privacy, security, or identity of the user. Typically, the sensitive data may include, but is not limited to, personally identifiable information, financial information, health records, login credentials and the like. Throughout the present disclosure, the term “user” refers to an individual or entity whose data is being processed, stored, or shared within the distributed network. Notably, the user is the owner or subject of the sensitive data. The user may include a customer, client, account holder and the like, or an organization whose personal, financial, or proprietary information is handled.

Throughout the present disclosure, the term “nodes” refers to the computing resources associated with multiple distinct financial institutions within a distributed network. Notably, the financial institutions may include, but are not limited to, banks, central banks, regulators, auditors, investors, payment and securities settlement systems, and other third parties. Moreover, each node amongst the plurality of nodes operates independently but collaborates with other nodes within the distributed network to achieve common objectives. Throughout the present disclosure, the term “first node” refers to the participant within the distributed network that is associated with the user. The term “second node” refers to another participant in the distributed network that receives data from the first node. The term “third node” refers to an additional participant in the distributed network that is brought into the process when a potential fraud or the fraud is detected, tracked and traced. It will be appreciated that there can be additional nodes amongst the plurality of nodes, other than the first node, the second node and the third node. Herein, the term “plurality of participants” refers to different entities that are represented as the plurality of nodes in the distributed network. Notably, each participant amongst the plurality of participants is represented by a corresponding node amongst the plurality of nodes.

Throughout the present disclosure, the term “first case” refers to an instance or a record within the collaborative database, which corresponds to a fraudulent activity associated with the first transaction conducted by the first node. Notably, the first case is generated after the internal validation of the fraudulent activity associated with the first transaction conducted by the first node from amongst the plurality of nodes. Throughout the present disclosure, the term “first transaction” refers to a financial transaction or data exchange performed by or initiated at the first node. Moreover, the first case is directly linked to the first transaction that is initiated by the first node from amongst the plurality of nodes. This linkage ensures that all actions, data, and subsequent events related to the first transaction are grouped under the first case within the collaborative database for coherent detection, tracking and processing. Advantageously, by creating the first case, the method ensures that there is a clear record of the first transaction initiated by the first node from amongst the plurality of nodes that can be used for auditing, fraud detection, tracking, tracing, and other collaborative purposes.

Throughout the present disclosure, the term “subscribing” refers to an action performed by the at least one node amongst the plurality of nodes within the distributed network to receive and access data related to the case. Notably, the first node registers its interest in initiating the first case related to the first transaction. Moreover, the purpose of subscribing to the first case is to enable the first node amongst the plurality of nodes to monitor and analyze the first transaction or activity associated with the first node.

Throughout the present disclosure, the term “cryptographic key” refers to a specific piece of digital information, typically a string of characters or a binary sequence, that is used in cryptographic algorithms to perform functions such as obfuscation, encryption, tokenization, authentication, and data integrity verification. Typically, the cryptographic key can be symmetric (the same key is used for both encryption and decryption) or asymmetric (a pair of keys, public and private, where one is used for encryption and the other for decryption). Herein, the term “first cryptographic key” refers to a unique digital key generated by the first node within the distributed network to tokenize the sensitive data associated with the transaction. The first node is responsible for creating the first case and associating the first case with the first transaction. Notably, the first cryptographic key corresponding to the first node is used to perform cryptographic operations, such as tokenization of the sensitive data associated with the user of the first node.

Throughout the present disclosure, the term “tokenizing” refers to a process of replacing the sensitive data with a non-sensitive token that conceals or masks original content of the sensitive data. Notably, the token retains certain essential information about the sensitive data without revealing the actual details of the user. Typically, the token is a randomly generated string using the first cryptographic key that can be mapped back to original sensitive data through a secure and controlled process. Furthermore, the tokenization is used to protect the sensitive data of the user while still allowing the data to be used within the distributed network without exposing the sensitive data of the user.

Optionally, the tokenization of the sensitive data is performed using a cryptographic algorithm selected from at least one of: a hashing algorithm, a symmetric encryption algorithm, an asymmetric encryption algorithm, a Format-Preserving Encryption (FPE). In this regard, the term “cryptographic algorithm” refers to a set of mathematical procedures that are used to perform encryption, decryption and other cryptographic operations. Typically, the cryptographic algorithms are essential for securing the sensitive data by transforming the sensitive data into a format that is unreadable or unusable by unauthorized nodes. Herein, the term “hashing algorithm” refers to a cryptographic algorithm that is used to transform the sensitive data into a fixed-size, unique string of characters (known as a hash value or digest) that represents the original data. Notably, the hashing algorithm enhances security of the sensitive data, once hashed, cannot be reverse-engineered or easily linked back to the original data. For example, Secure Hash algorithm 256-bit (SHA-256) is the hashing algorithm that generates a 256-bit hash value. The SHA-256 is used to hash the sensitive data of the user. Optionally, the hashing algorithms such as Hash-based Message Authentication Code (HMAC), SHA2, SHA3 can also be used to transform the sensitive data into the hash value. The term “symmetric encryption algorithm” refers to a type of cryptographic algorithm that is used for tokenizing the sensitive data through the encryption processes. Notably, in the symmetric algorithm the same cryptographic key is used for both the encryption and the decryption, which ensures that the original data remains confidential while allowing authorized users to access it by using the appropriate decryption key. For example, Advanced Encryption Standard (AES) is a symmetric algorithm that supports key sizes of 128, 192, or 256 bits. The term “asymmetric encryption algorithm” refers to a type of cryptographic algorithm that utilizes two distinct keys: a public key and a private key to tokenize the sensitive data of the user. Notably, the asymmetric algorithm can be used to securely encrypt the sensitive data such that only the intended node amongst the plurality of nodes with the corresponding private cryptographic key can decrypt it. For example, Rivest-Shamir-Adleman (RSA) algorithm is a widely used asymmetric encryption algorithm that employs key pairs for secure data encryption and decryption. The term “Format-Preserving Encryption” refers to a type of cryptographic algorithm used for tokenizing the sensitive data while maintaining the original format of the data. Notably, the Format-Preserving Encryption (FPE) does not change the length or structure of the encrypted output of the sensitive data and ensures that the encrypted data retains the same format as the original data. For example, when encrypting a 16-digit credit card number using the FPE, the encrypted output will also be a 16-digit number, making it suitable for environments where the format of the data must remain unchanged. A technical effect of using a cryptographic algorithm selected amongst the aforementioned algorithms is to provide protection to the sensitive data of the user transmitted across the distributed network. Additionally, the cryptographic algorithms enhance compliance with data protection regulations and reduces the risk of data breaches.

Throughout the present disclosure, the term “first case data” refers to a set of data associated with the first case generated by the first node amongst the plurality of nodes in the distributed network. Notably, the first case data is shared with the plurality of nodes (for example, other banks, payment service provider or other participants) within the distributed network. Herein, the term “case identifier” refers to a unique identifier assigned to the first case generated by the first node within the distributed network. Notably, the case identifier distinguishes the first case from other cases and track the progress of the first case across the plurality of participants.

Optionally, the case identifier comprises at least one of: a timestamp, a participant identifier. In this regard, the term “timestamp” refers to a specific date and time at which the first case is created by the first node. Typically, the timestamp is measured in a range from seconds to milliseconds. Notably, the timestamp ensures that the first case is identified based on the creation time of the first case, which is important for tracing the sequence of events, especially in fraud detection, tracking and tracing. Moreover, the timestamp may be automatically generated when the first case is created, ensuring accuracy and consistency. It can follow formats such as Unix time, ISO 8601 (for example, “2024-09-03T12:30:45Z”), or other standardized formats to ensure uniformity. The term “participant identifier” refers to a unique identifier assigned to a participant amongst the plurality of participants within the distributed network. Typically, the participant identifier can be a unique reference such as a number, alphanumeric code, or string. Notably, the participant identifier helps to distinguish and associate the participant with a particular case or transaction. Moreover, the participant identifier may be generated based on a pre-defined structure, such as a globally unique identifier (GUID), a company code, or a specific participant's identification number. Furthermore, inclusion of the participation identifier within the case identifier ensures that the case data can be accurately associated with the participant responsible for initiating or managing the case. A technical effect of including at least one of: a timestamp and a participant identifier within the case identifier helps to identify cases, prevent ambiguity and misattribution in collaborative systems involving multiple nodes and participants.

The term “tokenized data” refers to an encrypted or masked form of the sensitive data corresponding to the first transaction that is tokenized using the first cryptographic key. Notably, the tokenized data corresponding to the first transaction prevents the unauthorized access to the sensitive data of the user within the distributed network, making the sensitive data more secure to share across the distributed network. The sharing of the first case data enables the plurality of nodes in the distributed network to process, analyze or act on the transaction without comprising the privacy of the user. Furthermore, sharing of the tokenized data protects the sensitive data of the user while it still enables relevant nodes to process or analyze the first case data. The sharing of the case identifier and the first cryptographic key within the first case data ensures traceability and accountability, enables the plurality of nodes to verify the origin and integrity of the corresponding transaction data. The first node shares the first case data to the plurality of nodes in the distributed network.

Throughout the present disclosure, the second node amongst the plurality of nodes within the distributed network receives the first case data from the first node. Moreover, the purpose of receiving the first case data is to enable the second node to analyze the transaction data shared by the first node. The receiving step is crucial for enabling collaboration between different participants in the distributed network, facilitating fraud detection, tracking and tracing, and ensuring that the second node can contribute to the overall assessment of the first transaction.

Throughout the present disclosure, the term “subscribing” refers to a process by which the second node explicitly opts into or registers the interest in accessing the first case data. Notably, once the second node subscribes to the received first case, the second node is granted the access rights of the received first case, which may include decrypting or processing the received first case data, depending on the role of the second node in the distributed network. It will be appreciated that the subscription of the second node to the first case ensures that only authorized nodes amongst the plurality of nodes in the distributed network is able to access the first case data and promotes selective data sharing within the distributed network.

Throughout the present disclosure, the term “deciphering” refers to a process of converting the tokenized data in the received first case back into its original, readable form. Notably, the deciphering involves using the first cryptographic key (which was used to tokenize the sensitive data) to access and interpret the sensitive data of the user in the received first case data. Optionally, the method further comprises employing a machine learning model for deciphering the received first case data. In this regard, the term “machine learning model” refers to an artificial intelligence model that is used to assist in deciphering the received first case data. Notably, the machine learning model is trained using historical or sample data, including both normal and fraudulent transactions, to identify patterns, anomalies and the like in the first case data to enhance the process of interpreting the tokenized data. Optionally, the machine learning model performs the process of deciphering the received first case data through a lookup table. Moreover, for each token generated during the tokenization process, there is a corresponding clear value stored in the lookup table. Subsequently, the machine learning model compares the tokenized value to the corresponding clear value stored in the look up table. However, the process of deciphering can only be performed when the second node has the clear value of the tokenized first case data. This implies that if the second node does not have the clear value or the mapping in the lookup table, the second node cannot retrieve the original data from the token. Furthermore, the machine learning model may utilize features of the first case data such as metadata, the first cryptographic key, patterns in the tokenized data and the like to aid in accurately understanding and extracting the underlying sensitive information. A technical effect of employing the machine learning model is automate and expedite the deciphering process, thus, facilitating deciphering large volumes of tokenized data.

Notably, the deciphering allows the second node to participate in the fraud detection, tracking and tracing process by securely accessing the received first case data. Furthermore, since the sensitive data is tokenized in the first case for security reasons, the second node uses the shared first cryptographic key to decipher the received first case data. By allowing the second node to decipher the received first case data, the method enables interoperability between the plurality of nodes within the distributed network. Furthermore, use of the first cryptographic key ensures that the received first case data is not tempered with during transmission.

Throughout the present disclosure, the term “second case data” refers to a case data associated with the second transaction that occurred at the second node amongst the plurality of nodes within the distributed network. Herein, the term “second transaction” refers to a separate transaction conducted by the second node within the distributed network. The information and details related to the second transaction is provided in the second case data. Notably, the deciphered first case data and the second case data is compared, and the comparison involves various checks, such as identifying matching or suspicious transaction patterns, inconsistencies in account details, or unusual financial behavior. It will be appreciated that the primary reason for comparing the deciphered first case data with the second case data is to detect, track and trace potential fraud or suspicious activities, anomalies or patterns that indicate fraudulent behavior across different transactions. Moreover, by cross-referencing and comparing the data from multiple nodes, the method is able to detect, track and trace potential suspicious links between multiple transactions, which may not be apparent when looking at individual transaction data in isolation. Furthermore, the comparison ensures that the irregularities in financial transactions are flagged efficiently across the plurality of participants without revealing the sensitive data.

Throughout the present disclosure, the term “potential fraud” “suspicious activity”, or “suspicious transaction” refers to an abnormal, irregular or potentially fraudulent behavior detected during the comparison of the first case data with the second case data within the distributed network. Typically, the potential fraud or suspicious activity depends on specific guidelines within a country. However, the potential fraud or suspicious activity may be associated with the initiator and/or recipient account holder with past criminal activity, single use accounts (for example, no activity), machine learning models to detect suspicious behavioral patterns and the like activities. Notably, detecting, tracking and tracing the potential fraud or suspicious activity helps the plurality of nodes in the distributed network to mitigate risks, safeguard sensitive data, and prevent fraud by allowing them to take immediate action. Herein, the term “notifying” refers to a process of alerting or sending message from the second node to the third node within the distributed network after detection of the potential fraud or suspicious activity. Notably, notifying the third node informs the third node that a potential fraud or suspicious activity is identified in relation to the first transaction and the third node can subscribe to the first case data. Subsequently, after subscribing to the first case data, the third node is able to assess the situation or perform necessary remedial actions. It will be appreciated that the process of notifying the third node ensures that all relevant participants in the distributed network are made aware of potential threats or irregularities due to the identified potential fraud or suspicious activity, which helps in preventing fraud, protecting sensitive data, and maintaining the integrity of the distributed network. In an example, the comparison of the first case data with the second case data, or any subsequent case data, within the distributed network, is based on a comparison of any of: a type of data, a value of the data, a timestamp associated with the data, and so on. For example, a potential fraud or suspicious activity is said to have happened if value of a transaction at an initiator node A is not equal to a recipient node B, at a given timestamp associated with the transaction.

Optionally, the method further comprises sending an alert notification to a user device, of the participant associated with the subscribed second node and the subscribed third node, about the potential fraud in the distributed network. In this regard, the term “alert notification” refers to an alert message or warning about the potential fraud or suspicious activity in the distributed network. Herein, the term “user device” refers to an electronics device that is utilized by the participant to receive the alert notification related to the potential fraud or suspicious activity. Typically, the user device may include smartphone, tablet, laptop, and the like. Moreover, the alert notification is sent to the user device of the participant that is linked to the subscribed second node and to the user device of the subscribed third node. Furthermore, the alert notification contains information about the potential fraud or suspicious activity, potentially including details such as the case identifier, the nature of the potential fraud or suspicious activity, and instructions or next steps to perform. A technical effect of sending an alert notification to the user device is that the potential fraud or suspicious activities do not go unnoticed and can be addressed as quickly as possible. Additionally, the alert notification facilitates immediate awareness and possible intervention, reducing the time gap between detecting the potential fraud or suspicious activity and taking corrective action.

Optionally, the alert notification is sent using at least one of: API push, websocket push. In this regard, the term “API push” refers to a process of delivering the alert notification to the user device through an application programming interface (API) in a push model. Typically, the API push involves sending the alert notification from server to the user device without requiring the user device to explicitly request the alert. Notably, when the suspicious activity is detected, the server triggers the API that pushes the alert notification to the user device. The term “websocket push” refers to a process of using the websocket protocol for delivering the alert notification to the user device in a push-based model. Typically, the websocket push enables a full-duplex communication channel between the data processing arrangement and the user device, allowing the alert notification to be pushed from the data processing arrangement to the user device instantly. It will be appreciated that the websocket push provides low-latency updates without the overhead of constantly re-establishing connections between the data processing arrangement and the user device. A technical effect of using at least one of: API push, websocket push is that the both API push and websocket push ensure near-instant alert notification delivery, improving the user's ability to react quickly to the potential fraud or suspicious activity.

Optionally, the method further comprises utilizing the cryptographic key to reverse the tokenized sensitive data of the user associated with the first node, wherein the cryptographic key is passed on by the first node to and used by the subscribed second node and the subscribed third node to reverse the tokenized sensitive data when the subscribed second node and the subscribed third node possess the tokenized sensitive data from the first node. In this regard, the cryptographic key is shared with the authorized nodes such as the subscribed second node and the subscribed third node in the distributed network to interpret the tokenized sensitive data to its original form and access the original sensitive data associated with the first node. Optionally, the cryptographic key can be similar to the first cryptographic key, that is used to tokenize the sensitive data. It will be appreciated that by using the cryptographic key, the decryption algorithm is applied to the encrypted data. Subsequently, after applying the cryptographic key, the subscribed second node and the subscribed third node checks the look-up table for matching the tokenized data. The look-up table holds both the tokenized values and their corresponding clear (plain text) values. The given nodes use the look-up table to find the corresponding original clear data (decrypted value) from the tokenized data. This ensures that only nodes with permission and the required cryptographic key can successfully decrypt and compare the data. Moreover, in the distributed network where the sensitive data needs to be shared across multiple participants, it's essential to ensure that only authorized participants can access the original sensitive data. The cryptographic key allows secure and selective reversal of the tokenized sensitive data. A technical effect is that utilizing the cryptographic key ensures that the tokenized data can only be reverted by authorized entities, preventing unauthorized access to the sensitive data.

Herein, the third node amongst the plurality of nodes receives the first case data from the first node. Notably, the purpose of enabling the third node to receive the first case data is to involve additional participants in the detection of the potential fraud or suspicious transactions. Moreover, involving more nodes strengthens the collaborative effort to ensure transaction security within the distributed network.

Notably, in this regard, the term subscribing refers to a process by which the third node explicitly opts into or registers the interest in accessing the first case data. Notably, once the third node subscribes to the received first case, the third node is granted the access rights of the received first case, which may include decrypting or processing the received first case data, depending on the role of the third node in the distributed network. It will be appreciated that the subscription of the third node to the first case ensures that only authorized nodes amongst the plurality of nodes in the distributed network is able to access the first case data and promotes selective data sharing within the distributed network.

Notably, the deciphering involves using the first cryptographic key (which was used to tokenize the sensitive data) to access and interpret the sensitive data of the user in the received first case data. In this regard, the deciphering allows the third node to participate in the fraud detection process by securely accessing the received first case data. Furthermore, since the sensitive data is tokenized in the first case for security reasons, the third node uses the shared first cryptographic key to decipher the received first case data. By allowing the third node to decipher the received first case data, the method enables interoperability between the plurality of nodes within the distributed network. Furthermore, use of the first cryptographic key ensures that the received first case data is not tempered with during transmission.

Throughout the present disclosure, the term “third case data” refers to a case data associated with the third transaction that occurred corresponding to the third node amongst the plurality of nodes within the distributed network. Herein, the term “third transaction” refers to a separate transaction conducted by the third node within the distributed network. The information and details related to the third transaction is provided in the third case data. Notably, the deciphered first case data and the third case data is compared, and the comparison involves various checks, such as identifying matching or suspicious transaction patterns, inconsistencies in account details, or unusual financial behavior. It will be appreciated that the primary reason for comparing the deciphered first case data with the third case data is to detect, track and trace the potential frauds or suspicious activities.

Throughout the present disclosure, the phrase “one or more subsequent nodes” refers to additional nodes in the distributed nodes in the distributed network that are informed or alerted after the potential fraud or suspicious activity has been identified. Notably, the one or more subsequent nodes may not be directly involved in the initial analysis of the first case data but are notified to take further action, such as additional investigation, validation, or reporting. Moreover, notifying the one or more subsequent nodes informs the one or more subsequent nodes that a potential fraud or suspicious activity is identified in relation to the first transaction and the one or more subsequent nodes can subscribe to the first case data. Subsequently, after subscribing to the first case data, the one or more subsequent nodes is able to assess the situation or perform necessary remedial actions. It will be appreciated that the process of notifying the one or more subsequent nodes ensures that all relevant participants in the distributed network are made aware of potential threats or irregularities due to the identified potential frauds or suspicious activity, which helps in preventing fraud, protecting sensitive data, and maintaining the integrity of the distributed network.

Notably, after the potential fraud or suspicious activity is detected in the distributed network, at least one of the subscribed nodes (first, second, third, or subsequent nodes) is notified about either the second transaction, third transaction, or the one or more subsequent transactions, for detecting, tracking and tracing the potential fraud in the distributed network. The notifications are shared across relevant nodes involved in or related to the transaction data to ensure that all parties are aware of the potential risk. Moreover, the notification process ensures transparency, communication, and coordination among all relevant nodes in the network regarding the suspicious activity. It allows the distributed network to function collaboratively in detecting, tracking and tracing, preventing, and responding to fraudulent transactions. It will be appreciated that the notification process is the enhancement of the distributed network's ability to detect, track and trace, and respond to fraudulent transactions in a coordinated manner. This leads to a more secure and robust distributed network where participants can respond swiftly to threats, reducing potential risks or losses associated with fraudulent activities.

Optionally, the method further comprises generating a visual representation of the first node, the subscribed second node and the subscribed third node. In this regard, the term “visual representation” refers to a graphical representation that depicts the first node, the subscribed second node and the subscribed third node within the distributed network. Notably, the visual representation can be in the form of diagrams, graphs, charts, maps and the like that makes it easy to understand the interactions and communication flow between the aforementioned nodes within the distributed network. Moreover, representing the relationship between the plurality of nodes visually simplifies the complexity of understanding how the data flows and how the interaction takes place between the aforementioned nodes. A technical effect of generating the visual representation is that the user can quickly grasp the relationships between aforementioned nodes without needing to dive into detailed technical logs or code.

The present disclosure also relates to the non-transitory computer-readable medium as described above. Various embodiments and variants disclosed above, with respect to the aforementioned method, apply mutatis mutandis to the non-transitory computer-readable medium.

Throughout the present disclosure, the term “data processing arrangement” refers to programmable and/or non-programmable components configured to execute one or more software applications for storing, processing, sharing data and/or set of instructions. Optionally, the data processing arrangement is a set of one or more hardware components or a multi-processor system, depending on a particular implementation. More optionally, the data processing arrangement includes, for example, a component included within an electronic communications network. Additionally, the data processing arrangement includes one or more data processing facilities for storing, processing, sharing data and/or set of instructions. Optionally, the data processing arrangement includes functional components, for example, a processor, a memory, a network adapter and so forth.

Various embodiments and variants disclosed above, with respect to the aforementioned method apply mutatis mutandis to the system and to the non-transitory computer-readable medium.

Optionally, the data processing arrangement is further configured to generate a visual representation of the first node, the subscribed second node and the subscribed third node.

Optionally, the data processing arrangement is further configured to send an alert notification to a user device, of the user associated with the subscribed second node and the subscribed third node, about the potential fraud in the distributed network.

Optionally, the alert notification is sent using at least one of: API push, websocket push.

Optionally, the case identifier comprises at least one of: a timestamp, a participant identifier.

Optionally, the data processing arrangement is further configured to employ a machine learning model for deciphering the received first case data.

Optionally, the data processing arrangement is further configured to generate a second cryptographic key to reverse the tokenized sensitive data of the user associated with the first node, wherein the second cryptographic key is used by the subscribed second node and the subscribed third node to reverse the tokenized sensitive data when the subscribed second node and the subscribed third node possess the tokenized sensitive data.

Optionally, the tokenization of the sensitive data is performed using a cryptographic algorithm selected from at least one of: a hashing algorithm, a symmetric encryption algorithm, an asymmetric encryption algorithm, a Format-Preserving Encryption (FPE).

### EXPERIMENTAL PART

In an example, money trails enable case officers at Financial Institutions (FI), referred to as nodes hereafter, to track transactions associated with onward muling and laundering activities across payment schemes and financial institutions, thus leveraging payment data from all involved the data flow initiates with a case creation. This allows FIs to quickly identify suspected mule accounts and block or earmark fraudulently acquired funds. In a distributed data architecture consisting of multiple nodes in the network, the process works as follows: after a fraud (and its associated fraudulent transactions) has been reported by the consumer, validated and prioritized by the originating bank (or other authorized party such as law enforcement), it creates a case and other FIs are notified—this notification consists of a case identifier and cryptographic key. Other participating FIs subscribe to the case once they receive a suspicious transaction, and start to make available any new transactions that they match as onward muling from accounts of their customers to all other subscribing FIs. This step of making available new transactions to a case involves secure one-way encryption (called hashing), meaning that: Every participant can see a unique identifier, which we call proxy ID, for the transactions and accounts in question. The basis for these proxy IDs may vary in practice. A concrete example could be the bank's BIC combined with an internal account number (which is assumed to be unique for a given bank) to identify the account. A transaction can be represented by a transaction reference number that is visible to both parties. Proxy IDs are encrypted using secure one-way hashing prior to them being shared with anyone. One-way hashing is a cryptographic method by which an original value becomes obscured, and it is impossible to reconstruct even if one has the cryptographic key. After encryption, data is shared with other participants subscribing to the same case securely, without any participants being able to deduce the identity of any accounts involved, unless they can already see it. Thus, onward muling transactions become visible to subscribing FIs in an obscured fashion, surfacing only proxy IDs which are impossible to reverse-engineer into a real account number. Any bank on the network receiving a hashed transaction can match the contained proxy IDs with account numbers of their own customers by using the hashing process, and comparing the resulting value with the proxy ID that was received from other participants—but this is only possible if the bank is in possession of the original data. In this way, no new ownership of data is created.

In this regard, a node, such as a first node (F1), is notified of a case, namely a first case. It subsequently notifies all other nodes, such as a second node (F2) and a third node (F3) that a case was created as well as a cryptographic key used to securely anonymize data corresponding to the case, namely the first case data. Subsequently, steps of data transfer are initiated when F2 is notified by F1 as the recipient of the suspicious transaction. F2 then downloads the transaction value, timestamp, and anonymized account and transaction identifiers from F1. Herein, the money trail is visible to F1 and F2. Similarly, F3 is notified by F2 as the recipient of another suspicious transaction, this time for potential muling. F3 then downloads the transaction value, timestamp, and anonymized account and transaction identifiers from F2. Herein, the money trail is visible to F1 and F2 only. Similarly, all other stakeholders (which is only F1 in this case) of the first case are notified. These stakeholders then download the transaction value, timestamp, and anonymized account and transaction identifiers from F3. Herein, the money trail is visible to F1, F2 and F3, but not to any subsequent node, such as F4. Data sharing continues in a similar fashion for every new suspicious transaction connected to the first case, as they are discovered in real-time. Notably, at this stage, no sensitive data was shared, and nodes can only see their own account data. Herein, the money trail is visible to F1, F2, F3 and F4 as soon as a suspicious transaction is received. After establishing the common Money Trail, further data can be shared optionally (e.g. from F1 to all other participants), including for example: Mule and transaction status, any earmarked monies, Demographic data, Account holder identifiers (e.g. name, phone number). Herein, the money trail is visible to F1, F2, F3 and F4.

In another example, the system for detecting, tracking and tracing a potential fraud in a distributed network was implemented as a node-to-node (N2N) architecture. The N2N architecture provided a simpler approach by leaving sensitive data in the custody of its current owners, and only sharing encrypted data, thus lessening the burden and costs of data breaches, compliance, and operations. In this regard, a post-settlement solution for tracing illicit funds through chains of mules, was exhibited. It may be apricated that the approach could also be extended to other work streams, such as pre-settlement fraud scoring where techniques such as federated learning are unable to capture the full potential of the shared data. Finally, N2N architectures—with some modifications—could also apply to cross-border sharing of intelligence, or situations when data is hosted by multiple national payment switches.

### DETAILED DESCRIPTION OF THE DRAWINGS

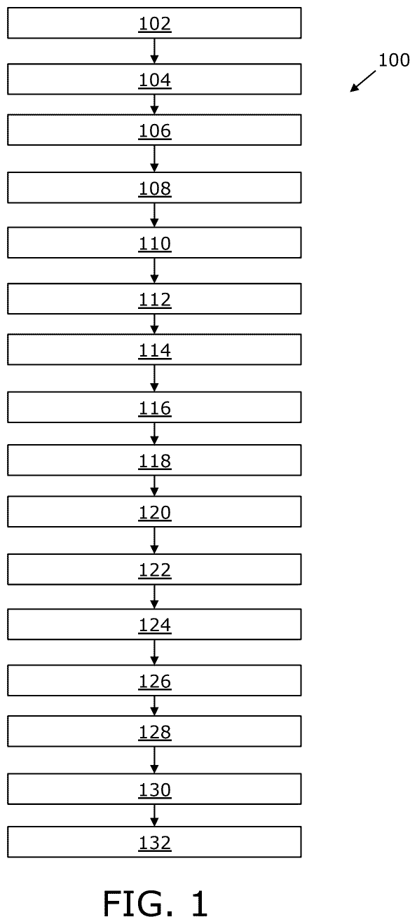

Referring to FIG. 1, illustrated is a flowchart depicting steps of a method for detecting, tracking and tracing a potential fraud in a distributed network, by obfuscating sensitive data of a user, in accordance with an embodiment of the present. At step 102, a first case corresponding to a first transaction is created. At step 104, the first node is subscribed to the first case. At step 106, a first cryptographic key associated with the first node is generated. At step 108, the sensitive data is tokenized based on the first cryptographic key. At step 110, the first case data is shared with the plurality of nodes in the distributed network associated with the first case wherein the first case data comprises: a case identifier, a first cryptographic key associated with the first node, and the tokenized data corresponding to the first transaction. At step 112, the first case data is received by the second node. At step 114, the second node subscribed to the first case. At step 116, the received first case data is deciphered using the first cryptographic key. At step 118, the deciphered first case data is compared with second case data corresponding to a second transaction. At step 120, the third node of the first transaction is notified, when the compared first case and second case data are different, for detecting, tracking and tracing the potential fraud in the distributed network. At step 122, the first case data is received by the third node. At step 124, the third node is subscribed to the first case. At step 126, the received first case data is deciphered using the first cryptographic key. At step 128, the deciphered first case data is compared with third case data corresponding to a third transaction. At step 130, one or more subsequent nodes of the first transaction is notified, when the compared first case and third case data are different, for detecting, tracking and tracing the potential fraud in the distributed network. At step 132, at least one of the subscribed first node, second node, third node, one or more subsequent nodes is notified of the at least one of the second transaction, the third transaction, one or more subsequent transaction, for detecting, tracking and tracing the potential fraud in the distributed network.

The aforementioned steps are only illustrative, and other alternatives can also be provided where one or more steps are added, one or more steps are removed, or one or more steps are provided in a different sequence without departing from the scope of the claims herein.

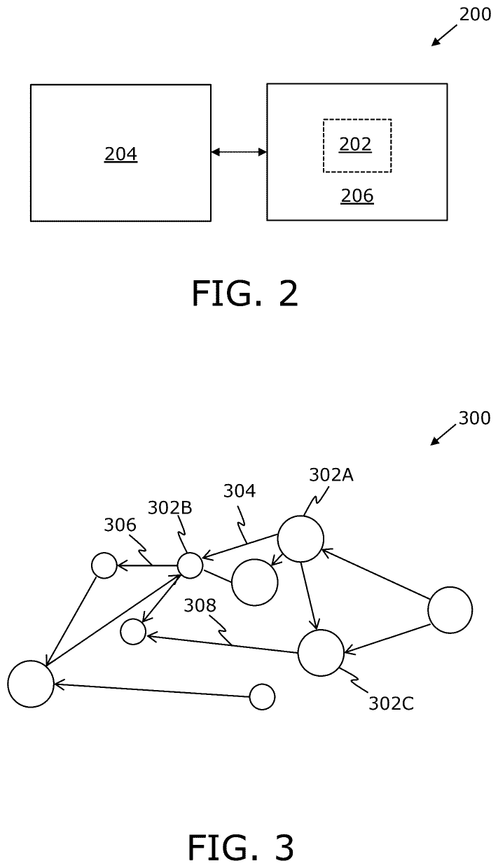

Referring to FIG. 2, illustrated is a block diagram of a system 200 for detecting, tracking and tracing a potential fraud in a distributed network, in accordance with an embodiment of the present disclosure. The system 200 comprises a data processing arrangement 204. Moreover, the system 200 comprises a plurality of nodes representing a plurality of participants, wherein the plurality of nodes at least includes a first node, a second node and a third node, wherein the first node is associated with a user having sensitive data 202. The data processing arrangement 204 is configured to create a distributed network of a plurality of nodes representing a plurality of participants. Furthermore, the data processing arrangement 204 is configured to send an alert notification to a user device 206, of the user associated with the subscribed second node and the subscribed third node, about the potential fraud in the distributed network.

FIG. 2 is merely an example, which should not unduly limit the scope of the claims herein. It is to be understood that the specific implementations of the system 200 are provided as examples and are not to be construed as limiting it to specific numbers, sizes, or shapes of the data processing arrangement 204, and similar. A person skilled in the art will recognize many variations, alternatives, and modifications of embodiments of the present disclosure.

Referring to FIG. 3, illustrated is a schematic illustration of a distributed network 300, in accordance with an embodiment of the present disclosure. The distributed network 300 comprises a distribute network of a plurality of nodes (depicted as nodes 302A, 302B, 302C). Moreover, a first transaction initiated by a first node 302A from amongst the plurality of nodes 302A-C. Furthermore, the first node 302A shares a first case data 304 with the plurality of nodes (depicted as the node 302B, 302C) in the distributed network 300, wherein the first case data 304 comprises: a case identifier, a first cryptographic key associated with the first node 302A, and the tokenized data corresponding to the first transaction. Furthermore, the second node 302B from amongst the plurality of nodes 302A-C received the first case data 304 and subscribes to the received first case data 304 to access the first case data 304. Furthermore, a second transaction is performed by the second node 302B. Furthermore, the second node 302B generates a second case data (depicted as a second case data 306) corresponding to the second transaction by the second node 302B, to be compared with the deciphered first case data 304. Furthermore, third node (depicted as the node 302C) is received the first case data 304 and is subscribed to the received first case data 304, when the compared data indicates a potential fraud in the distributed network 300. Furthermore, a third transaction is performed by the third node 302C. Furthermore, the third node 302C generates a third case data (depicted as a third case data 308) corresponding to the third transaction by the third node 302C, to be compared with the deciphered first case data 304. A difference in the compared first case data 304 with the second case data 306 or the third case data 308 is indicative of a potential fraud in the distributed network 300.

1. A method for detecting, tracking and tracing a potential fraud in a computer network (300) comprising a plurality of nodes (302A-C) representing a plurality of participants, wherein the plurality of nodes at least includes a first node (302A), a second node (302B) and a third node (302C), wherein the first node is associated with a user having sensitive data,
the method comprising enabling the first node for:
generating a first case corresponding to a first transaction;
subscribing to the first case;
generating a first cryptographic key associated with the first node;
tokenizing the sensitive data based on the first cryptographic key; and
sharing the first case data (304) with the plurality of nodes in network associated with the first case, wherein the first case data comprises:
a case identifier,
the first cryptographic key, and
the tokenized data corresponding to the first transaction;
wherein the method comprises enabling the second node for:
receiving the first case data:
subscribing to the first case;
deciphering the received first case data using the first cryptographic key;
comparing the deciphered first case data with second case data (306) corresponding to a second transaction; and
notifying the third node of the first transaction, when the compared first case and second case data are different, for detecting, tracking and tracing a potential fraud in a network;
wherein the method comprises enabling the third node for:
receiving the first case data;
subscribing to the first case;
deciphering the received first case data using the first cryptographic key;
comparing the deciphered first case data with third case data (308) corresponding to a third transaction; and
notifying one or more subsequent nodes of the first transaction, when the compared first case and third case data are different, for detecting, tracking and tracing the potential fraud in the network,
wherein the method comprises notifying at least one of the subscribed first node, second node, third node, one or more subsequent nodes of the at least one of the second transaction, the third transaction, one or more subsequent transaction, for detecting, tracking and tracing the potential fraud in the network.

2. The method of claim 1, further comprising generating a visual representation of the first node (302A), the subscribed second node (302B) and the subscribed third node (302C).

3. The method of claim 1, further comprising sending an alert notification to a user device, of the participant associated with the subscribed second node (302B) and the user associated with the third node (302C), respectively, about the potential fraud in the network (300).

4. The method of claim 3, wherein the alert notification is sent using at least one of: API push, websocket push.

5. The method of claim 1, wherein the case identifier comprises at least one of: a timestamp, a participant identifier.

6. The method of claim 1, further comprises employing a machine learning model for deciphering the received first case data (304).

7. The method of any of preceding claims, further comprising utilizing the cryptographic key to decipher the tokenized sensitive data (202) of the user associated with the first node (302A), wherein the cryptographic key is passed on by the first node to and used by the subscribed second node (302B) and the subscribed third node (302C) to decipher the tokenized sensitive data when the subscribed second node and the subscribed third node possess the tokenized sensitive data.

8. The method of any of preceding claims, wherein the tokenization of the sensitive data (202) is performed using a cryptographic algorithm selected from at least one of: a hashing algorithm, a symmetric encryption algorithm, an asymmetric encryption algorithm, a Format-Preserving Encryption (FPE).

9. A non-transitory computer-readable medium carrying instructions that when loaded into and executed by a data processing arrangement (204) causes the data processing arrangement to execute operations, the operations comprising steps of a method of claim 1.

10. A system (200) for detecting, tracking and tracing a potential fraud in a computer network (300) comprising a plurality of nodes (302A-C) representing a plurality of participants, wherein the plurality of nodes at least includes a first node (302A), a second node (302B) and a third node (302C), wherein the first node is associated with a user having sensitive data, the system comprising a data processing arrangement (204),
wherein the data processing arrangement is configured to enable the first node to:
generate a first case corresponding to a first transaction;
subscribe to the first case;
generate a first cryptographic key associated with the first node;
tokenize the sensitive data based on the first cryptographic key; and
share the first case data (304) with the plurality of nodes in the network associated with the first case, wherein the first case data comprises:
a case identifier,
the first cryptographic key, and
the tokenized data corresponding to the first transaction;
wherein the data processing arrangement is configured to enable the second node to:
receive the first case data:
subscribe to the first case;
decipher the received first case data using the first cryptographic key;
compare the deciphered first case data with second case data (306) corresponding to a second transaction; and
notify the third node of the first transaction, when the compared first case and second case data are different, for detecting, tracking and tracing the potential fraud in the network;
wherein the data processing arrangement is configured to enable the third node to:
receive the first case data;
subscribe to the first case;
decipher the received first case data using the first cryptographic key;
compare the deciphered first case data with third case data (308) corresponding to a third transaction; and
notify one or more subsequent nodes of the first transaction, when the compared first case and third case data are different, for detecting, tracking and tracing the potential fraud in the network; and
wherein the data processing arrangement is configured to notify at least one of the subscribed first node, second node, third node, one or more subsequent nodes of the at least one of the second transaction, the third transaction, one or more subsequent transaction, for detecting, tracking and tracing the potential fraud in the network.

11. The system (200) of claim 10, wherein the data processing arrangement (204) is further configured to generate a visual representation of the first node (302A), the subscribed second node (302B) and the subscribed third node (302C).

12. The system (200) of claim 10, wherein the data processing arrangement (204) is further configured to send an alert notification to a user device, of the participant associated with the subscribed second node (302B) and the user associated with the subscribed third node (302C), respectively, about the potential fraud in the network (300).

13. The system (200) of claim 12, wherein the alert notification is sent using at least one of: API push, websocket push.

14. The system (200) of claim 10, wherein the case identifier comprises at least one of: a timestamp, a participant identifier.

15. The system (200) of claim 10, wherein the data processing arrangement (204) is further configured to employ a machine learning model for deciphering the received first case data (304).

16. The system (200) of claim 10, wherein the data processing arrangement (204) is further configured to utilize the cryptographic key to decipher the tokenized sensitive data (202) of the user associated with the first node (302A), wherein the cryptographic key is passed on by the first node to and used by the subscribed second node (302B) and the subscribed third node (302C) to decipher the tokenized sensitive data when the subscribed second node and the subscribed third node possess the tokenized sensitive data.

17. The system (200) of claim 10, wherein the tokenization of the sensitive data (202) is performed using a cryptographic algorithm selected from at least one of: a hashing algorithm, a symmetric encryption algorithm, an asymmetric encryption algorithm, a Format-Preserving Encryption (FPE).
